(19) United States
(12) Patent Application Publication
(10) Pub. No.: US 2022/0031554 A1
(43) Pub. Date: Feb. 3, 2022

(54) KNOCKING STRUCTURE OF DOUBLE-HEAD FASCIA MASSAGER

(71) Applicant: YONG KANG AIJIU INDUSTRIAL & TRADE CO.,LTD, Jinghua (CN)

(72) Inventors: Yu Hu, Jinhua (CN); Qiuya Cheng, Jinhua (CN)

(73) Assignee: YONG KANG AIJIU INDUSTRIAL & TRADE CO.,LTD, Jinghua (CN)

(21) Appl. No.: 17/168,092

(22) Filed: Feb. 4, 2021

(30) Foreign Application Priority Data
Jul. 30, 2020 (CN) 2020215523741
Jan. 15, 2021 (CN) 2021201168791

(51) Int. Cl. A61H 7/00

(52) U.S. Cl. CPC A61H 7/005; A61H 2201/1669; A61H 2201/1654

(57) ABSTRACT

A knocking structure of double-head fascia massager is disclosed. The knocking structure includes a motor fixed in a housing of the massager and a rotating shaft driven by the motor. The rotating shaft is arranged on both sides of an axis of the motor. Transmissions are arranged on both sides of the rotating shaft, and pistons are connected with the transmissions. The pistons are constrained to move in two nozzles of the housing. The transmissions drive the two pistons to reciprocate in a staggered manner. Two massage heads are connected to the pistons, and different massage heads reciprocate in a staggered manner. An advantage of the present disclosure is that one motor controls the simultaneous movement of the two massage heads, and two massage heads move back and forth to massage body, which speeds up the frequency of massage and increases the area.

### TECHNICAL FIELD

The present disclosure relates to the field of fascia massager, and more specifically, to a knocking structure of double-head fascia massager.

### BACKGROUND

The fascia massager, also known as deep muscle and fascia impactor, is a soft tissue rehabilitation tool which relaxes the soft tissue of the body through high-frequency impact, and is a good tool to help the stretching after exercise for professional athletes or amateur gymnasts. For professional athletes or ordinary leisure lovers, aches and pains exist. The fascia massager alleviates the muscle spasm and increases the blood flow with the vibration frequency, which resolves the muscle problems in a shorter time.

Most of the fascia massagers on the market are designed as single-head, with small knock range and low massage efficiency, and can continue to massage other parts only after one part is well massaged. There are also double-head muscles and collaterals massagers designed like application publication number CN111135051A. But the range of striking of this double-headed fascia gun is limited, only one massage head can be selected for striking, and the vertical grip is too painful for wrist massage.

### SUMMARY

The technical problem to be solved by the present disclosure is to provide a fascia massager which is capable of simultaneously massaging the body with two massage heads.

The technical scheme of the present disclosure is as follows: a knocking structure of double-head fascia massager, including:

a motor fixed in a housing of the massager;

a rotating shaft driven by the motor and arranged on both sides of an axis of the motor;

two nozzles fixed on the housing;

two pistons arranged in different nozzles movably;

two sets of transmissions arranged on the rotating shaft on both sides of the motor with the piston being connected with the transmission on the same side, wherein the two sets of transmissions drive the two pistons to reciprocate in a staggered manner; and

two massage heads connected to the different pistons, wherein the different massage heads reciprocate in a staggered manner.

Further, the rotating shaft penetrates through the motor and protrudes from both sides of the motor.

Further, the rotating shaft is a motor shaft of the motor.

Further, each transmission includes an eccentric wheel connected with the rotating shaft of the motor and a rocker; one end of the rocker is rotatably coupled with the eccentric wheel, and the other end is rotatably connected with the piston; the piston reciprocates along an extension direction of the nozzle.

Further, the eccentric shafts on the eccentric wheels on both sides of the motor are always not collinear during rotating, and the eccentric shafts are connected with the rockers.

Further, the massage heads are located outside the housing during the whole process of a reciprocating motion.

Further, one massage head is in a longest extended position while the other massage head is in a shortest retracted position.

Further, the axis of the rotating shaft of the motor is perpendicular to a moving direction of the two pistons.

Further, the axis of the rotating shaft of the motor is horizontal.

Further, at least one side of the motor is provided with a support; the support is fixedly connected on the housing, and the rotating shaft of the motor is connected with the transmission through the support.

Compared with the prior art, an advantage of the present disclosure is that the motor is provided with a rotating shaft penetrating through the motor, the two massage heads are connected to both sides of the motor in dislocation, one motor controls the simultaneous movement of the two massage heads, and two massage heads move back and forth to massage a body, which speeds up the frequency of massage and increases the area.

### BRIEF DESCRIPTION OF THE DRAWINGS

Hereinafter, the present disclosure will be described in further detail with reference to the accompanying drawing and preferred embodiments. However, it will be appreciated that, for those skilled in the art, the drawings are drawn merely for the purpose of illustrating the background art and explaining the preferred embodiments, and therefore should not be taken as limiting the scope of the disclosure. In addition, unless specified, the drawings are merely illustrative in conceptual representation of the composition or construction of the objects described and may include exaggerated displays, and are not necessarily drawn to scale.

FIG. 1 is a schematic diagram of the housing and grip of Embodiment 1.

FIG. 2 is a breakdown diagram of the grip and the rear end cover of Embodiment 1.

FIG. 3 is a schematic diagram of the opening housing of Embodiment 1.

FIG. 4 is an arrangement diagram of the of the knocking transmission structure of Embodiment 1.

FIG. 5 is a breakdown diagram of the knocking transmission structure of Embodiment 1.

FIG. 6 is a structure diagram of the knocking transmission structure of Embodiment 1.

FIG. 7 is a schematic diagram of the motor and the rotating shaft of Embodiment 1.

FIG. 8 is a breakdown diagram of the knocking transmission structure of Embodiment 1.

FIG. 9 is a three-dimensional schematic diagram of the fascia massager of Embodiment 2.

FIG. 10 is a linkage relationship diagram of the motor and the transmissions of Embodiment 2.

FIG. 11 is a linkage relationship diagram of the motor and the transmissions of Embodiment 2.

FIG. 12 is a sectional view of the fascia massager of Embodiment 2.

FIG. 13 is a schematic diagram of the interior of the housing of the fascia massager of Embodiment 2.

### DETAILED DESCRIPTION OF EMBODIMENTS

The present disclosure is further described in combination with the drawings and specific embodiments. Those skilled in the art may understand that these descriptions are merely for illustrative, exemplary purpose, and should not be construed as limiting the scope of the disclosure.

### Embodiment 1

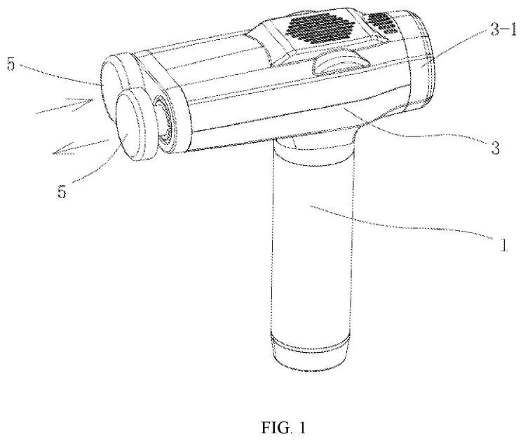

As shown in FIG. 1, the main part of the fascia massager includes a housing 3 and a grip 1. The housing 3 and the grip 1 are L-shaped. A battery cavity 14 is arranged in the grip 1, and the battery 13 is arranged in the battery cavity 14. The housing 3 can be opened and closed up and down. The upper housing 3 and the lower housing 3 are connected by screws, and a cavity between the upper housing 3 and the lower housing 3 is arranged for placing the structure of the disclosure.

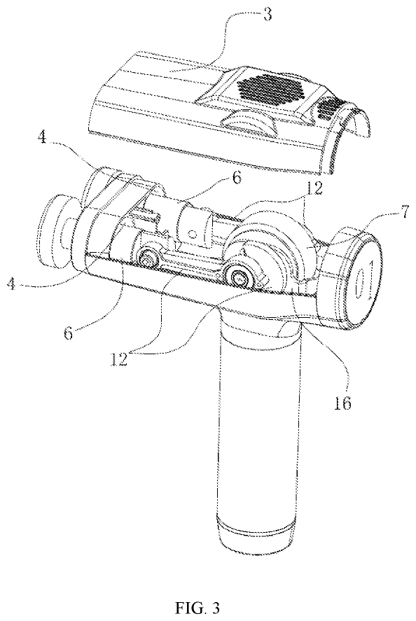

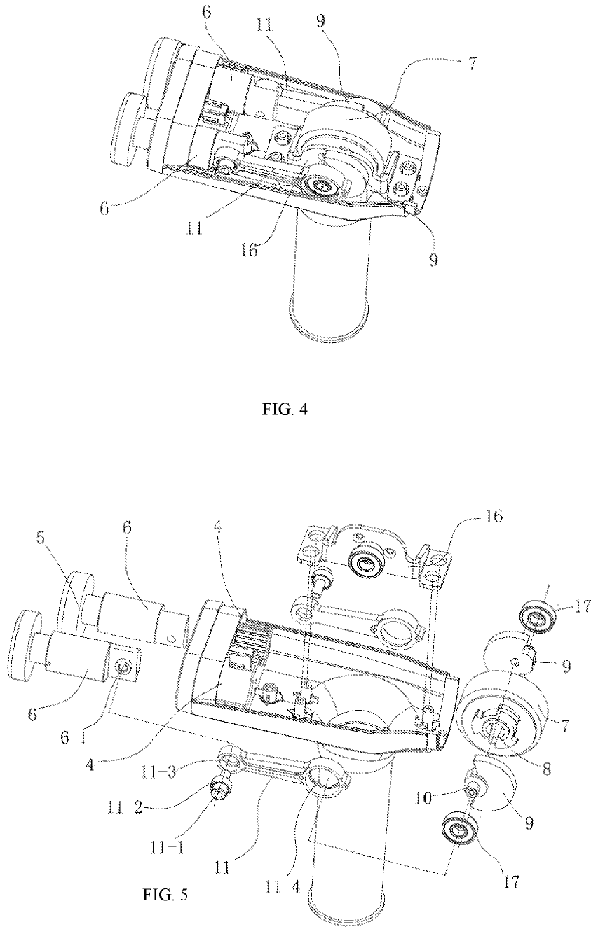

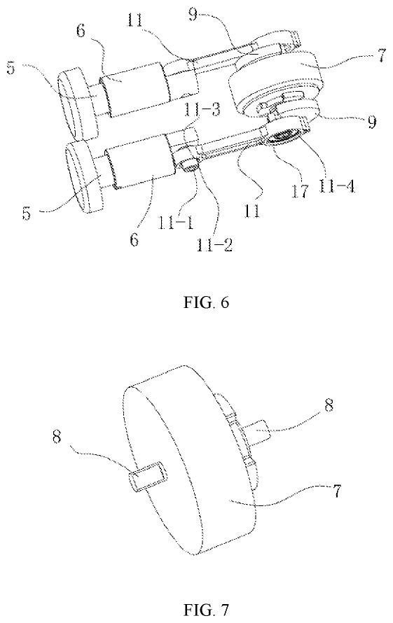

As shown in FIG. 3 and FIG. 4, the knocking structure of double-head fascia massager includes a motor 7 arranged in the cavity of the housing 3. A support 16 is arranged in the housing 3, and the support 16 is fixed on one side of the motor 7. Preferably, the support 16 is fixed on the housing 3 by screws. The motor 7 is fixed on the support 16 by screws, and the rotating shaft 8 passes through the support 16. As shown in FIG. 7, the motor 7 is provided with a rotating shaft 8 penetrating through the motor 7, and the rotating shaft 8 is the motor shaft of the motor 7.

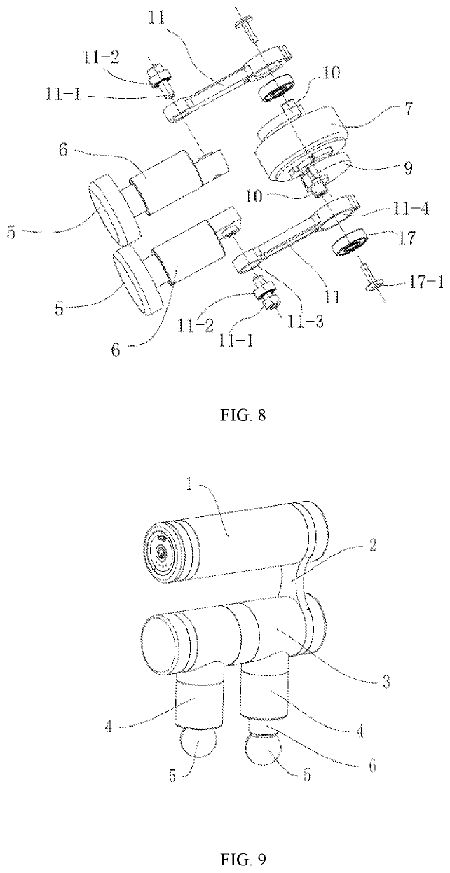

As shown in FIG.3, two transmissions 12 are connected to the rotating shaft 8 on both sides of the motor 7. In particularly, as shown in FIG.5, FIG.6 and FIG. 8, each transmission 12 includes an eccentric wheel 9 coupled to the rotating shaft 8 of the motor 7 and a rocker 11. The rotating part of each eccentric wheel 9 is fixedly connected to the rotating shaft 8, and each eccentric wheel 9 is provided with an eccentric shaft 10. One end of the rocker 11 is pivotally coupled with the eccentric shaft 10, and the other end of the rocker 11 is pivotally coupled with the piston 6.

As shown in FIG. 3, two parallel nozzles 4 are provided on the housing 3. The pistons 6 are confined within the nozzles 4. The rocker 11 push the pistons 6 to reciprocate once in the extending direction of the nozzles 4 every time they rotate. The pistons 6 are connected with the massage heads 5 which are arranged outside of the housing 3, and two massage heads reciprocate in a staggered manner.

The form in which the two massage heads 5 move on both sides of the motor 7 is more stable than that on one side, reducing jitter. Since there are two massage heads 5 massaging the body at the same time, the two massage heads 5 can knocking the body in a wide range, and the staggered reciprocating motion of the two massage heads 5 increases the frequency of massaging.

As shown in FIG. 8, the rotation center line of the eccentric wheel 9 is perpendicular to the movement direction of the pistons 6. The axis of the rotation shaft 8 of the motor 7 is perpendicular to the motion directions of the two pistons 6.

Since the rotating shaft 8 of the motor 7 drives the eccentric wheels 9 on both sides to rotate, the axes of the eccentric shafts 10 on both side eccentric wheels 9 are always not collinear during the rotation process, so that the two massage heads 5 realize the staggered reciprocating motion.

In operation, when the eccentric shaft 10 of an eccentric wheel 9 on one side is at the farthest position from the corresponding nozzle 4, the eccentric shaft 10 on the other side is at the closest position from the corresponding nozzle 4. At this time, the eccentric shafts 10 of the eccentric wheels 9 on both sides are in two extreme positions, so that one massage head 5 is in the most extended position, and the other one is in a shortest retracted position. However, the eccentric shafts 10 of the eccentric wheels 9 on both sides are not limited to two extreme positions. For example, when the eccentric shaft 10 of one side eccentric wheel 9 is located farthest from the corresponding nozzle 4, the eccentric shaft 10 of the eccentric 9 on the other side is located between the most distant and the closest position to the corresponding nozzle 4, and makes a movement toward the farthest or closest position.

Preferably, each piston 6 is provided with a socket, and the massage head 5 is inserted in the socket of the piston 6 to facilitate the replacement of different massage heads 5.

Working principle: The eccentric wheels 9 on both sides are driven to rotate by the rotation shaft 8 of the motor 7. The rotation of the eccentric wheels 9 drive the rockers 11 to swing, and the rockers 11 drive the pistons 6 and the massage heads 5 to reciprocate. The two massage heads 5 reciprocate in rhythmic dislocation.

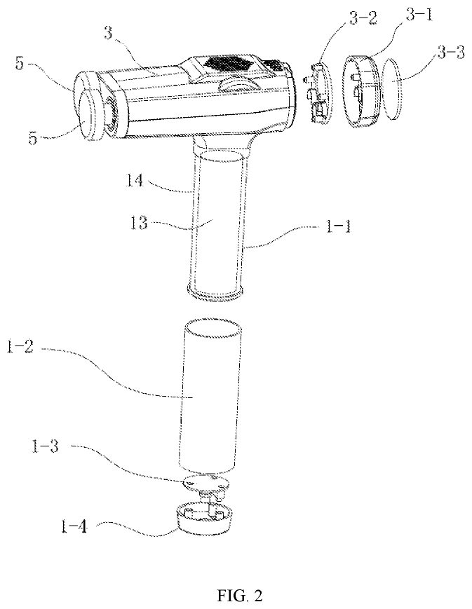

As shown in FIG. 1 and FIG. 2, the rest parts are the same as the existing fascia massager, including the circuit board components inside the fascia massager, the charging port and switch button outside the housing 3 or grip 1 of the fascia massager, and the display screen 3-3. The housing 3 and each part of the grip 1 can be detachably connected, so as to facilitate disassembly and installation.

For example, as shown in FIG. 2, the bottom of the grip 1 is provided with a lower end cover 1-4 and a charging circuit board 1-3. The charging circuit board 1-3 is fixed on the lower end cover 1-4. Charging wires are connected to the charging circuit board 1-3. The charging circuit board 1-3 is electrically connected to and charges the battery 13. The grip 1 is divided into an inner grip 1-1 and an outer body 1-2, and the outer body 2 is enclosed outside the inner grip 1-1. The outer body 1-2 may be a soft glue layer.

A rear end cover 3-1, a control circuit board and a circuit board support 3-2 are arranged at the rear of the housing 3, and a display screen 3-3 is arranged on the rear end cover 3-1 for touch control and gear adjustment. The control circuit board is electrically connected to the display screen 3-3, the motor 7 and the battery 13. Preferably, the motor 7 is a brushless motor 7.

Preferably, as shown in FIG. 5, FIG. 6 and FIG. 8, each rocker 11 includes a front sleeve hole 11-3 and a rear sleeve hole 11. Each piston 6 is provided with a hinge shaft hole. A bolt 11-1 and a front bearing 11-2 is arranged in the front sleeve hole 11-3. The bolt 11-1 is provided through the center of the front bearing 11-2 to be connected to the hinge shaft hole of the piston 6. The front sleeve hole 11-3 is connected to the outer ring of the front bearing 11-2, and is tightly pressed into the front sleeve hole 11-3. The bolt 11-1 is connected to the inner ring of the front bearing 11-2, and the head portion of the bolt 11-1 is larger than the inner ring of the front bearing 11-2, so that the head portion of the bolt 11-1 limits the axial disengagement of the forward bearing 11-2.

Preferably, the rear sleeve hole 11-4 is internally connected to a bearing 17 which is tightly pressed into the rear sleeve hole 11-4. The inner ring of the bearing 17 is tightly press-fitted onto the eccentric shaft 10 of the eccentric wheel 9. In order to ensure stability, a screw 17-1 is attached to the eccentric shaft 10, the head of which is larger than the inner ring of the bearing 17 and limits the axial disengagement of the bearing 17.

The above numbers indicate:1 grip; 1-1 inner grip; 1-2 outer body; 1-3 charging circuit board; 1-4 lower end cover; 3 housing; 3-1 rear end cover; 3-2 circuit board support; 3-3 display screen; 4 nozzle; 5 massage head; 6 piston; 7 motor; 8 rotating shaft; 9 eccentric wheel; 10 eccentric shaft; 11 rocker; 11-1 bolt; 11-2 front bearing; 11-3 front sleeve hole; 11-4 rear sleeve hole; 12 transmission; 13 battery; 14 battery cavity; 15 connection hole; 16 support; 17 bearing; 17-1 screw.

### Embodiment 2

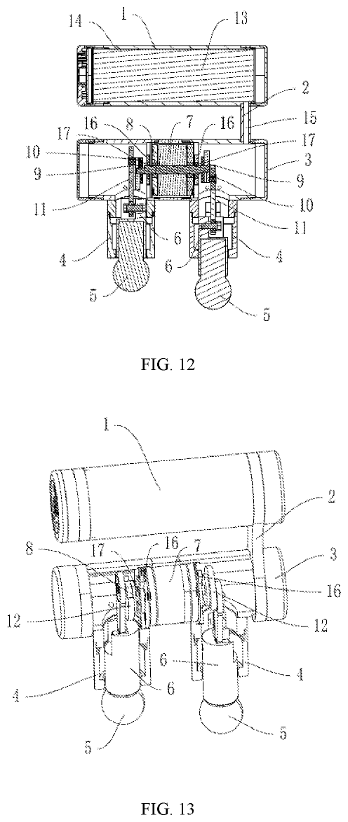

Referring to FIG. 9 and FIG. 12, the main body part of the fascia massager of the embodiment includes a housing 3 and a grip 1. The grip 1 and the housing 3 are connected by a support frame 2. The housing 3, grip 1 and support frame 2 are enclosed to form a hand insertion space. Users hold the grip 1 by hand during the massage. The extending direction of the housing 3 is parallel to an extending direction of the grip 1. A battery cavity 14 is arranged in the grip 1, and a battery 13 is arranged in the battery cavity 14. The structure of grip 1 is convenient to hold.

As shown in FIG. 12, the grip 1 and the housing 3 can be connected by one support frame 2 or a plurality of support frames 2. The wires in the grip 1 can be electrically connected to the motor 7 through the connection hole 15 provided in the support frame 2 into the housing 3.

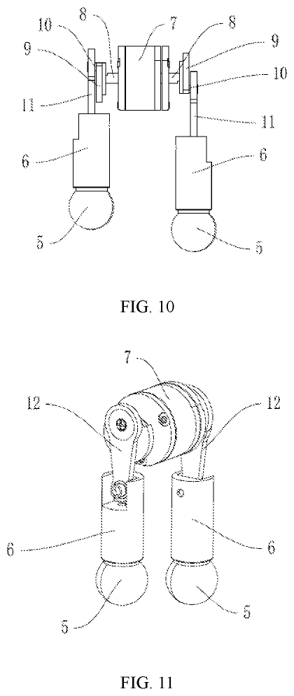

Referring to FIG. 10, FIG. 11 and FIG. 12, the housing 3 is provided with a knocking structure of double-head fascia massager. More specifically, the knocking structure of double-head fascia massager includes a motor 7 arranged in the housing 3. The motor 7 is provided with a rotating shaft 8 penetrating through the motor 7. The rotating shaft 8 is the motor shaft.

Two transmissions 12 are connected to the rotating shaft 8 on both sides of the electric motor 7, in particularly, each transmission 12 includes an eccentric wheel 9 coupled to the rotating shaft 8 of the motor 7 and a rocker 11. Each eccentric wheel 9 is provided with an eccentric shaft 10. One end of the rocker 11 is pivotally coupled with the eccentric shaft 10, and the other end the rocker 11 is pivotally coupled a piston 6. Two parallel nozzles 4 are provided on the housing 3. The pistons 6 are confined within the nozzles 4. The rockers 11 push the pistons 6 to reciprocate once in the extending direction of the nozzles 4 every time they rotate. The pistons 6 are connected with the massage heads 5 which are arranged outside of the housing 3, and two massage heads reciprocate in a staggered manner. As shown in FIG.9, the housing 3 and the grip 1 are cylindrical.

The motor 7 is located in the middle of the housing 3 for stability. Secondly, the form in which the two massage heads 5 move on both sides of the motor 7 is more stable than that on one side, reducing jitter. Since there are two massage heads 5 massaging the body at the same time, the two massage heads 5 can strike the body in a wide range, and the staggered reciprocating motion of the two massage heads 5 increases the frequency of massaging.

The rotation center line of the eccentric wheel 9 is perpendicular to the movement direction of the pistons 6. The axis of the rotation shaft 8 of the motor 7 is perpendicular to the motion directions of the two pistons 6.

As shown in FIG. 10, since the rotating shaft 8 of the motor 7 drives the eccentric wheels 9 on both sides to rotate, the axes of the eccentric shafts 10 on both side eccentric wheels are always not collinear during the rotation process, so that the two massage heads 5 realize the staggered reciprocating motion. Preferably, when the eccentric shaft 10 of an eccentric wheel 9 on one side is at the farthest position from the corresponding nozzle 4, the eccentric shaft 10 on the other side is at the closest position from the corresponding nozzle 4. At this time, the eccentric shafts 10 of the eccentric wheels 9 on both sides are in two extreme positions, so that one massage head 5 is in the most extended position, and the other one is in a shortest retracted position. However, the eccentric shafts 10 of the eccentric wheels 9 on both sides are not limited to two extreme positions. For example, when the eccentric shaft 10 of one side eccentric wheel 9 is located farthest from the corresponding nozzle 4, the eccentric shaft 10 of the eccentric 9 on the other side is located between the most distant and the closest position to the corresponding nozzle 4, and makes a movement toward the farthest or closest position.

As shown in FIG. 13, at least one side of the motor 7 is provided with a support 16, preferably both sides of the motor 7 are provided with supports 16. The supports 16 are fixedly connected on the housing 3. The rotating shaft 8 on both sides of the motor 7 is connected with the transmission 12 through the supports 16, and bearings 17 are provided between the supports 16 and the rotating shaft 8. The supports 16 and the bearings 17 serve to support the rotating shaft 8 on both sides of the motor 7, so that the rotating shafts 8 is kept horizontal all the time, thereby preventing the rotation shafts 8 of the motor 7 from swinging during rotation.

As shown in FIG. 4, the grip 1 and the housing 3 can be connected by one support frame 2 or multiple support frames 2. The wire in the grip 1 is electrically connected to the motor 7 through the connection hole 15 provided in the support frame 2 into the housing 3.

Preferably, each of the pistons 6 is provided with a socket. The massage head 5 includes a rubber part and a connecting part which is inserted into the socket of the piston 6 to facilitate the replacement of different massage heads 5 having different shapes.

Working principle: The eccentric wheels 9 on both sides are driven to rotate by the rotation shaft 8 of the motor 7. The rotation of the eccentric wheels 9 drive the rockers 11 to swing, and the rockers 11 drive the pistons 6 and the massage heads 5 to reciprocate. The two massage heads 5 reciprocate in rhythmic dislocation.

As shown in FIG. 9, The rest parts are the same as the existing fascia massager, including the circuit board component, the charging port and the switch button provided outside the housing 3 or the grip 1 of the fascia massager, and the display screen.

The housing 3 and each part of the grip 1 are detachably connected for easy disassembly and installation.

The above numbers indicate: 1 grip; 2 support frame; 3 housing; 4 nozzle; 5 massage heads; 6 piston; 7 motor; 8 rotating shaft; 9 eccentric wheels; 10 eccentric shaft; 11 rocker; 12 transmission; 13, battery; 14 battery cavity; 15 connection hole; 16 support; 17 bearing.

Specific examples are used herein to set forth the principles and embodiments of the present disclosure, and the description of the above examples is provided only to assist in understanding the disclosure and the core ideas. It should be understood that any modifications, replacements or changes made by those skilled in the art without departing from the spirit of the disclosure shall fall within the scope of the disclosure.

What is claimed is:

1. A knocking structure of double-head fascia massager, comprising:
a motor fixed in a housing of the massager;
a rotating shaft driven by the motor and provided on both sides of an axis of the motor;
two nozzles fixed on the housing;
two pistons provided in different nozzles and being movable;
two sets of transmissions arranged on the rotating shaft on both sides of the motor with the pistons being connected with the transmissions on the same side;
wherein the two sets of transmissions drive the two pistons to reciprocate in a staggered manner; and
two massage heads connected to the different pistons; and the different massage heads reciprocate in a staggered manner.

2. The knocking structure of double-head fascia massager of claim 1, wherein the rotating shaft penetrates through the motor and protrudes from both sides of the motor.

3. The knocking structure of double-head fascia massager of claim 2, wherein the rotating shaft is a motor shaft of the motor.

4. The knocking structure of double-head fascia massager of claim 3, wherein each transmissions comprises an eccentric wheel connected with the rotating shaft of the motor and a rocker; one end of the rocker is rotatably coupled with the eccentric wheel, and the other end is rotatably coupled with the piston; and the piston reciprocates along an extension direction of the nozzle.

5. The knocking structure of double-head fascia massager of claim 4, wherein the eccentric shafts on the eccentric wheels on both sides of the motor are always not collinear during rotating, and the eccentric shafts are connected with the rockers.

6. The knocking structure of double-head fascia massager of claim 1, wherein the massage heads are located outside the housing during the whole process of a reciprocating motion.

7. The knocking structure of double-head fascia massager of claim 1, wherein one massage head is in a longest extended position while the other massage head is in a shortest retracted position.

8. The knocking structure of double-head fascia massager of claim 1, wherein the axis of the rotating shaft of the motor is perpendicular to a moving direction of the two pistons.

9. The knocking structure of double-head fascia massager of claim 8, wherein an axis of the rotating shaft of the motor is horizontal.

10. The knocking structure of double-head fascia massager of claim 1, wherein at least one side of the motor is provided with a support; the support is fixedly connected on the housing, and the rotating shaft of the motor is connected with the transmissions through the support.
